(19) United States
(12) Patent Application Publication
(10) Pub. No.: US 2002/0165809 A1
(43) Pub. Date: Nov. 7, 2002

(54) Process for packaging and securitization of future crude oil and natural gas production streams

(76) Inventor: Edward Gendelman, Littleton, CO (US)

Correspondence Address: Edwin H. Crabtree, 3773 Cherry Creek N. Drive, Suite 575, Denver, CO, 80209, US

(21) Appl. No.: 09/848,090

(22) Filed: May 2, 2001

(51) Int. Cl. G06F 17/60

(52) U.S. Cl. 705/36; 705/35

(57) ABSTRACT

A process for packaging and securitizing future oil and gas production stream from one or more wells. The process is based on the relative predictability of future oil and gas production levels. The predictability of future production permits the creation of a “production backed security” supported by a revenue stream derived from the packaged oil and gas production. The process includes first establishing a trust managed by a trustee or a fund managed by a fund manager. The trust is used for purchasing oil and gas production streams from one or more oil and gas producer. At the same time, an engineering data and asset management service develops a comprehensive database related to the oil and gas wells and their production. The database is used for analyzing and monitoring the oil and gas production streams to be purchased from the oil and gas producer. The trust then issues and sells the production backed securities to investors. The trust then pays the oil and gas producer from a portion of the proceeds from the sale of the security. Also, the process can include hedging the production backed securities using a commodity price hedge. The hedging of the security helps reduce the risk related to future price fluctuations of oil and gas. Further, the process can include a security guarantee and/or other credit enhancements. Still further, a security rating agency can be used to rate the production backed securities based on fluctuations in price, political, governmental and geographical risks related to the operation of the wells and the location.

### BACKGROUND OF THE INVENTION

(a) Field of the Invention

This invention relates to the securitization of future production of a natural resource and more particularly, but not by way of limitation, to a process for packaging and securitization of future oil and natural gas production streams from one or more wells.

(b) Discussion of Prior Art

In the United States, there are roughly 2 billion barrels of oil and 12 trillion cubic feet of natural gas produced annually. World wide, there are roughly 23 billion barrels of oil and 30 trillion cubic feet of natural gas produced annually. This production translates into a stream of annual revenue, which can be made predictable when properly risk managed and insured, of over $100 billion and $500 billion in the United States and worldwide respectively. With the right data management tools and appropriate risk management techniques some of this revenue could potentially be packaged and securitized. Accordingly, the packaging and securitizing of this revenue stream presents a very large financial opportunity waiting to be exploited. With the recent development of systems for energy asset management used in managing very large volumes of oil and gas production data, it is now possible to realize the financial opportunity described herein.

Heretofore, oil and gas producers, especially smaller producers, producers with high debt/equity ratios and those working outside the United States, as well as the governments of many oil producing countries, currently have limited options as to financing their field development, monetizing their assets or risk managing their production. The subject securitization process will greatly broaden oil and gas producers financing and risk management capabilities along with providing them with an opportunity to access financial markets at credit ratings higher than their current corporate ratings.

In U.S. Pat. No. 5,806,048 to Kiron et al., a mutual fund securitization process is described. The securitization process is designed to allow the trading of open end mutual funds on or off the floor of a National Security Exchange. In U.S. Pat. No. 5,812,988 to Sandretto, a method and system for imputing economic variables and estimating financial statements, future asset values, risks, etc is disclosed. In U.S. Pat. No. 5,987,435 to Weiss to al., a data processing system is described for managing and implementing a form of security called “Proxy Asset”. In U.S. Pat. No. 6,112,188 to Hartnett, a method of using advanced communications of financial market trading for developing and implementing economic policies is described.

None of these prior art patents specifically disclose or teach the unique features, objects and advantages of the subject process for the securitization of future crude oil and natural gas production.

### SUMMARY OF THE INVENTION

In view of the foregoing, it is a primary objective of the subject invention to provide a process for packaging and securitizing future oil and gas production streams from one or more wells. This process creates a new way in which oil and gas producing companies and governments of oil and gas producing countries can access financial markets with an opportunity to access funding markets at a credit rating higher then their own current corporate rating. Also, the new process provides an oil and gas producer with greatly broadened financing and risk management capabilities.

Another object of the invention is to create a new “production backed security” based on current and future oil and gas production. The new security can be sold to investors with various degrees of risk and rate of return on the investment.

Still another object of the new securitizing process is the security based on the relative predictability of future oil and gas production levels over a certain period of time.

Yet another object of the invention is the production backed security can be enhanced by hedging the commodity prices. The hedging of the security helps reduce the risk to an investor as to future price fluctuations of oil and gas.

A further object of the process is through the use of a finance or insurance company, the production backed security can be issued having a guaranteed rate of return to the investor.

Another object of the new security process is a security rating agency can be used to rate the production backed security based on fluctuations in price, political, governmental and geographical risks related to the operation of the wells and the location and geology of the oil and gas production.

The packaging and securitization process includes the first step of establishing a trust or a fund managed by a trustee or a fund manager. The trust is used for purchasing an oil and gas production stream from an oil and gas producer. At the same time, an engineering and data management service develops a comprehensive database related to the oil and gas wells and their production. The database is used for analyzing and monitoring the oil and gas production stream to be purchased from the oil and gas producer. The trust then issues and sells the production backed security to investors. The trust then pays the oil and gas producer from a portion of the proceeds from the sale of the security.

The process can also include hedging the production backed security using a commodity price hedge. The hedging of the security helps reduce the risk related to future price fluctuations of oil and gas. Further, the process can include a guaranteed rate of return of the security to the investor by using credit enhancements and security insurance. Still further, a security rating agency can be used to rate the production backed security based on fluctuations in price, political, governmental and geographical risks related to the operation of the wells and the location and geology of the oil and gas production.

These and other objects of the present invention will become apparent to those familiar with different types of financial securities and the selling of crude oil and natural gas production when reviewing the following detailed description, showing novel construction, combination, and elements as herein described, and more particularly defined by the claims, it being understood that changes in the embodiments to the herein disclosed invention are meant to be included as coming within the scope of the claims, except insofar as they may be precluded by the prior art.

### BRIEF DESCRIPTION OF THE DRAWINGS

The accompanying drawings illustrate complete preferred embodiments in the present invention according to the best modes presently devised for the practical application of the principles thereof, and in which:

FIG. 1 is a block diagram illustrating the individual components of creating the new “production backed security” and the steps used in packaging and securitizing the oil and gas product streams from one or more wells. FIG. 1 also includes optional components that can be used with different forms of the new security.

### DESCRIPTION OF THE PREFERRED EMBODIMENTS

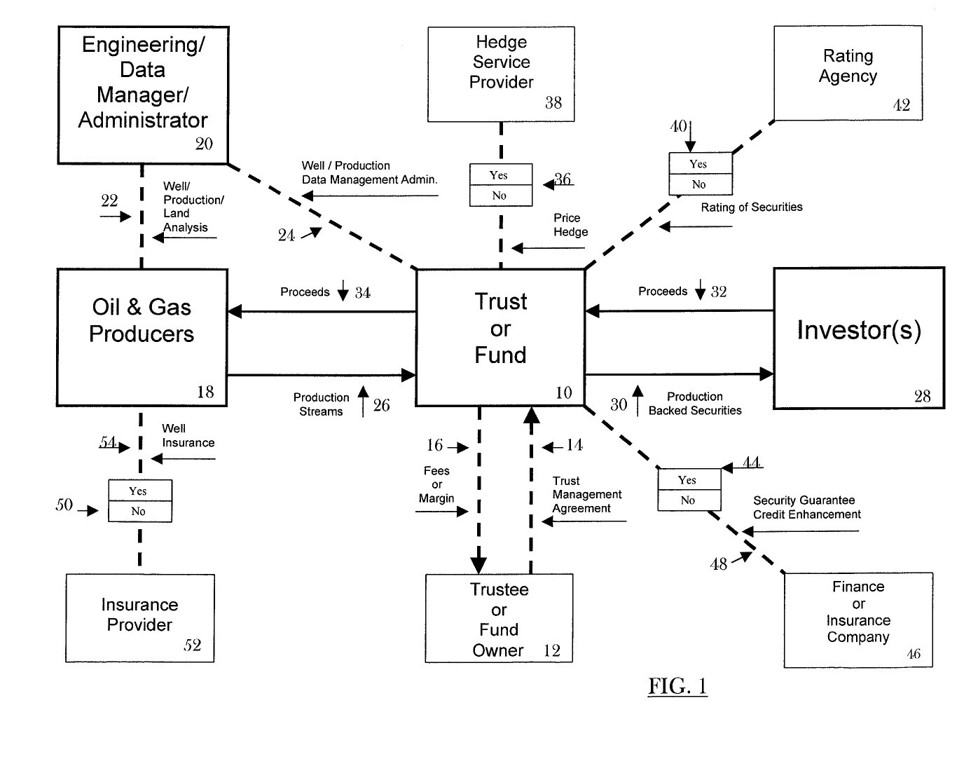

In FIG. 1, a block diagram is shown of the individual components used in making up the process related to the new “production backed security” along with optional components that may or may not be used with the new security. It should be mentioned that while one production backed security is described herein, there can be a number of different types of production backed securities securitized by production streams from different oil and gas producers located in various parts of the world. Also, there can be any number of investors purchasing the oil and gas production backed securities. The securities having various rates of interest to the investors depending on the nature of the risk involved.

The process first includes the establishing of an oil and gas trust 10 or fund. The trust 10 is operated by a trustee 12 or fund owner operating under a trust management agreement, indicated by line 14. The trust 10 in turn pays the trustee 12 a management fee or a margin of the trust profits, as indicated by line 16.

Once the trust 10 has been established, an oil and gas producer 18 is contacted and a proposed standardized contract is offered to the oil and gas producer by the trustee 12. The proposed contract includes, among other items, a list of required data from the producer 18 for each well being packaged into the security. The list of required data for each well includes ownership data (such as mineral ownership, leases, assignments, recordings, etc.), production histories (oil, gas, water, etc.), technical well data (logs, cores, tests, well designs, etc.) and operating data (LOE's, taxes, division orders, production sale, purchase records, etc.).

When the required data from the oil and gas producer 18 is received by the trustee 12, an energy engineering/data manager/administrator 20 is used to provide a well, production and land ownership analysis, as indicated by line 22, and perform standard ownership due diligence and accounting of the data. At this time, the engineering/data manager/administrator 20 reformats all of the data, builds additional databases and loads the well production data into a data management system. The well production data is available for review by an authorized user anywhere in the world and at anytime, as indicated by line 24.

The engineering/data manager/administrator 20, working with the trustee 12, uses the database to produce a conservative future productivity “decline curve”. The decline curve will be produced for each well or package of wells from the same production area. The data manager/administrator 20 will then “haircut” or discount the decline curve by determining a conservative percentage of the resulting curve. The percentage of the decline curve, which may be in a range of 5 to 100%, will represent the production stream to be securitized. For example, if the oil and gas producer 18 has a current level of production at 10,000 barrels of oil per day with the wells located in the United States, the agreed upon percentage of the decline curve might be 50% over a 3 to 5 year period or longer. Obviously, the location of the wells, the amount of production in the field, the favorability of additional production in the area, the stability of the government, etc., will all influence the agreed upon percent of the decline curve and the amount of production to be packaged and securitized.

Also, it should be mentioned that the oil and gas producer will be required to provide the engineering/data manager/administrator 20 with periodic information updates related to each well or package of wells that are part of the securitization program. The data provided will be continually added to the data system and cross-checked, so that there is always up to date information on each well in the package along with ongoing monitoring of the purchased oil and gas production stream.

Once the production stream is purchased by the trust 10, as indicated by line 26, the production backed security issued by the trust 10 is sold to one or more investors 28, as indicated by line 30. The proceeds, as indicated by line 32, from the investor 28 is paid to the trust 10. At this time, a percent of the proceeds is paid to the oil and gas producer, as indicated by line 34. As mentioned above, the subject process creates a new way in which oil and gas producing companies and governments of oil and gas producing countries can access financial markets with an opportunity to access finding for current and future oil and gas production at a credit rating higher then their own current corporate rating.

Shown in FIG. 1, are the following optional components that can be used with different forms of the new process for creating the production backed security. The trustee 12 may or may not, as indicated by a “Yes/No” box 36, use a hedge service provider 38. If the trustee 12 determines that the future prices of oil and gas for a certain period may be unstable, then the trustee may elect to hedge the prices of oil and gas for that period of time. The cost of the hedge service will be factored into the cost of the production backed security sold to the investor. But, in this example, the new security will be protected against unforeseen changes in the pricing of oil and gas and will have a high security rating.

Also, the trustee 12, may or may not, as indicated by “Yes/No” box 40, use a rating agency 42 for rating a particular production backed security. If the trustee 12 hedges the security and uses the rating agency 42, obviously the security will have a higher rating then a security with no hedge backing.

Further, the trustee 12, may or may not, as indicated by “Yes/No” box 44, use a Finance or Insurance Company 46 for insuring or guaranteeing the production backed security. The credit enhancement, as indicated by line 48, will further raise the rating of the issued securities.

Still further, if the oil and gas producer 18 does not already have well insurance for the wells being securitized, the trustee 12 has the option to request or not request, as indicated by “Yes/No” box 50, well insurance, as indicated by line 54, from a insurance provider 52.

As mentioned above, the new oil and gas production backed security may take on various forms with different rates of return for the investor 28. The following are examples of higher risk securities. One type of security might be a high risk, high return passthrough hedge instrument wherein the security is not hedged. Should the price of oil and gas move upwardly while the investor owns this type of security, then obviously the value of the security will greatly increase. Also, the new security may be commodity specific. For example, the production stream that is securitized is based only on oil production or only on natural gas production. Further, the security may be area specific. For example, the production stream that is securiitized is based on a particular oil field in the United States or a country in the Middle East. Still further, the new security may have an added risk and reward of including yet undrilled wells (exploration wells) in a particular area to be developed. If the exploration is successful, then the valve of the security is increased substantially. Yet another example of the security is the securitization of a production stream in a country having an international political risk. If the political risk is diminished or removed, then the investor is rewarded by a security having greatly increased value.

For a more conservative investor, the production backed security may be price hedged using the hedge service provider 38 and rated by the rating agency 42. This security can also be guaranteed by the finance or insurance company 46 for providing the investor 28 with a fixed rate of return during the life of the security. From reviewing the above process for creating the subject production backed security, it can be appreciated by those familiar with financing various forms of oil and gas projects that the subject invention provides an oil and gas producer with improved and broadened financial and risk management capabilities.

While the invention has been particularly shown, described and illustrated in detail with reference to the preferred embodiments and modifications thereof, it should be understood by those skilled in the art that equivalent changes in form and detail may be made therein without departing from the true spirit and scope of the invention as claimed except as precluded by the prior art.

The embodiments of the invention for which an exclusive privilege and property right is claimed are defined as follows:

1. A process for packaging and securitizing future oil and gas production stream or streams from one or more oil and gas wells and creating a “production backed security”, the process steps comprising:
establishing an oil and gas trust, the trust managed by a trustee;
developing a comprehensive database related to a proposed purchase of an oil and gas production stream based on engineering data received from an oil and gas producer and related to the oil and gas wells and their production;
analyzing the engineering data to determine if the oil and gas production stream should be purchased;
purchasing the oil and gas production stream from one or more oil and gas wells by the trustee from the oil and gas producer;
issuing and selling a production backed security based on the oil and gas production stream by the trustee to one or more investors;
paying the oil and gas producer from a portion of the proceeds from the sale of the security to the investor; and
monitoring the oil and gas production stream purchased from the oil and gas producer.

2. The process as described in claim 1 wherein the step of analyzing the engineering data includes creating a decline curve related to current and future production of the oil and gas production stream and discounting the decline curve prior to purchasing the oil and gas production stream.

3. The process as described in claim 1 further including the step of hedging a commodity price on the oil and gas production stream prior to issuing and selling the security to one or more investors.

4. The process as described in claim 1 further including the step of providing a rating of the production backed security using a rating agency prior to issuing and selling the security to one or more investors.

5. The process as described in claim 1 further including the step of insuring and guaranteeing the production backed security using a finance or insurance company prior to issuing and selling the security to one or more investors.

6. The process as described in claim 1 further including the step of requesting and obtaining well insurance from the oil and gas producer on the oil and gas wells providing the oil and gas stream prior to purchasing the oil and gas stream.

7. A process for packaging and securitizing future oil and gas production stream or streams from one or more oil and gas wells and creating a “production backed security”, the process steps comprising:
establishing an oil and gas trust, the trust managed by a trustee;
developing a comprehensive database related to a proposed purchase of an oil and gas production stream or streams based on engineering data received from an oil and gas producer and related to the oil and gas wells and their production;
analyzing the engineering data to determine if the oil and gas production stream or streams should be purchased and creating a decline curve related to current and future production of the oil and gas production stream or streams and discounting the decline curve prior to purchasing the oil and gas stream or streams;
insuring the oil and gas wells providing the oil and gas production stream or streams;
purchasing the oil and gas production stream or streams from one or more oil and gas wells by the trustee from the oil and gas producer;
issuing and selling a production backed security based on the production stream or streams by the trustee to one or more investors;
paying the oil and gas producer from a portion of the proceeds from the sale of the security to the investor; and.
monitoring the oil and gas production stream or streams purchased from the oil and gas producer.

8. The process as described in claim 7 wherein the step of analyzing the engineering data and creating a decline curve related to current and future production of the oil and gas production stream or streams and discounting the decline curve is in a range of 5 to 100% prior to purchasing the oil and gas stream.

9. The process as described in claim 7 further including the step of hedging a commodity price on the oil and gas production stream or streams prior to selling the security to an investor.

10. The process as described in claim 7 further including the step of providing a rating of the production backed security using a rating agency and prior to issuing and selling the security to one or more investors.

11. The process as described in claim 7 further including the step of credit enhancing the production backed security using a finance or insurance company and prior to issuing and selling the security to one or more investors.

12. A process for packaging and securitizing future oil and gas production stream or streams from one or more oil and gas wells and creating a “production backed security”, the process steps comprising:
establishing an oil and gas trust, the trust managed by a trustee;
developing a comprehensive database related to a proposed purchase of an oil and gas production stream or streams based on engineering data received from an oil and gas producer and related to the oil and gas wells and their production;
analyzing the engineering data to determine if the oil and gas production stream or streams should be purchased and creating a decline curve related to current and future production of the oil and gas production stream or streams and discounting the decline curve in a range of 5 to 100% for a 3 to 5 year prior to purchasing the oil and gas stream or streams;
insuring the oil and gas wells providing the oil and gas production stream or streams;
purchasing the oil and gas production stream or streams from one or more oil and gas wells by the trustee from the oil and gas producer;
issuing and selling a production backed security based on the production stream or streams by the trustee to one or more investors;
paying the oil and gas producer from a portion of the proceeds from the sale of the security to the investor; and.
monitoring the oil and gas production stream or streams purchased from the oil and gas producer.

13. The process as described in claim 12 wherein the step of analyzing the engineering data and creating a decline curve related to current and future production of the oil and gas production stream or streams and discounting the decline curve is in a range of 5 to 100% prior to purchasing the oil and gas stream.

14. The process as described in claim 12 further including the step of hedging a commodity price on the oil and gas production stream or streams prior to selling the security to an investor.

15. The process as described in claim 12 further including the step of providing a rating of the production backed security using a rating agency and prior to issuing and selling the security to one or more investors.

16. The process as described in claim 12 further including the step of credit enhancing the production backed security using a finance or insurance company and prior to issuing and selling the security to one or more investors.
